(19) United States
(12) Patent Application Publication
(10) Pub. No.: US 2009/0096934 A1
(43) Pub. Date: Apr. 16, 2009

(54) Television receiver and liquid crystal television receiver

(75) Inventors: Nobuo Nakajima, Tokyo (JP); Koichi Gyoda, Tokyo (JP); Eiji Shibuya, Kobe-shi (JP); Takehiro Onomatsu, Osaka (JP); Hideto Yoshimura, Osaka (JP)

Correspondence Address: Yokoi & Company U.S.A., INC., 13700 Marina Pointe Drive, Suite #723, Marina Del Rey, CA, 90292, US

(73) Assignees: THE UNIVERSITY OF ELECTRO-COMMUNICATIONS, Tokyo (JP); DX Antenna Company, Limited, Hyogo-ken (JP); Funai Electric Co., Ltd., Osaka (JP)

(21) Appl. No.: 12/287,425

(22) Filed: Oct. 9, 2008

(30) Foreign Application Priority Data
Oct. 10, 2007 (JP) JP2007-264357

(51) Int. Cl. H04N 5/44

(52) U.S. Cl. 348/725; 348/E05.096

(57) ABSTRACT

A television receiver having an antenna function for receiving broadcast signals includes an antenna group having plural variable directivities and including plural antennas formed in plural parts on inner and outer surfaces of walls of a cabinet or nonmetallic surfaces of component parts arranged in the cabinet so as to conform to the shapes of the corresponding surfaces, respectively, and a switching control unit capable of specifying a directivity for the antenna group to receive broadcast signals by the antenna group.

### CROSS REFERENCE TO RELATED APPLICATIONS

The present application is related to the Japan Utility Model Application No. 2007-264357, filed Oct. 10, 2007 the entire disclosure of which is expressly incorporated by reference herein.

### BACKGROUND OF THE INVENTION

1. Field of the Invention

The present invention relates to a television receiver having an antenna function

2. Description of the Related Art

A television receiver mentioned in JP-A H11-308554 (Patent document 1) has a receiving unit including two loop antennas, namely, right and left loop antennas, affixed to a peripheral part of a front cabinet, the front surface of a CRT or the funnel of a CRT or incorporated into a front cabinet by insert molding.

A digital television receiver disclosed in JP-A 2005-102142 (Patent document 2) has two electronically tunable aperture waveguide antennas built in or attached to receiving unit for phase synthesis diversity receiving.

A portable telephone mentioned in JP-A 2006-13629 (Patent document 3) is provided with an annular broadcast receiving antenna placed in the peripheral surface of a case.

An electronic apparatus mentioned in JP-A H5-335826 (Patent document 4) is provided with an antenna placed in a display to transmit radio-frequency signals to a receiving unit.

A portable digital assistant (PDA) mentioned in JP-A 2003-143030 (Patent document 5) provided with wiring boards placed in a case and each provided with an antenna and a ground pattern for the antenna.

When a television receiver is provided with a built-in antenna, a problem arises in the receiving ability of the antenna. The television receiver is installed at a position in a direction desired by the user in the room. Therefore, the direction of the antenna is dependent on the direction of the television receiver, which is one of all directions. Under such circumstances, if the sensitivity of the antenna to broadcast signals is greatly dependent on the direction of the television receiver, the quality and reliability of the television receiver will be markedly deteriorated. Thus, the television receiver with a built-in antenna is required to have a high receiving ability capable of receiving broadcast signals on a selected channel in a satisfactory sensitivity regardless of the direction of the television receiver and of not picking up unnecessary signals.

Since the television receiver disclosed in Patent document 1 receives television signals by the two loop antennas, namely, the right and the left loop antenna, the receiving sensitivity is greatly dependent on the direction of the television receiver and becomes very low when the television receiver is directed in some direction. Consequently, the television receiver cannot possibly satisfy a receiving ability required by the user.

The right and the left aperture waveguide antenna of the digital television receiver disclosed in Patent document 2 are placed in a cabinet and are wide and have a considerably big height in the direction of the thickness of the cabinet. Therefore, the thickness of the cabinet unavoidably needs to be considerably big to build the aperture waveguide antennas in the cabinet. Thus, it is difficult for the digital television receiver to meet the recently desired reduction of the thickness of the television receiver. Moreover, the large aperture waveguide antennas having a big height reduce the degree of freedom of designing and arranging other component parts to be placed in the cabinet.

Patent documents 3 to 5 do not solve the foregoing problem in the receiving ability of the television receiver.

### BRIEF SUMMARY OF THE INVENTION

The present invention provides a television receiver capable of receiving desired broadcast signals in a satisfactory sensitivity and of not picking up unnecessary signals regardless of the direction of the television receiver, of being formed in a small thickness, of increasing the degree of freedom of designing and arrangement of component parts to be placed in a cabinet.

A television receiver according to the present invention has an antenna function for receiving broadcast signals, extracts signals of a predetermined frequency from the received broadcast signals, generates video signals by using the signals of the predetermined frequency, and displays images represented by the video signals. The television receiver has an antenna group having plural directivities and including plural antennas formed in plural positions on inner and outer surfaces of walls of a cabinet of the television receiver and/or on nonmetallic surfaces of components arranged in the cabinet so as to conform to shapes of the corresponding surfaces, respectively. A switching control unit specifies a directivity of the antenna group to receive broadcast signals by the antenna group.

The present invention integrates the antennas with the television receiver by forming the antennas respectively at different positions on the inner and the outer surfaces of the walls of the cabinet or on the nonmetallic surfaces of component parts arranged in the cabinet so as to conform to the shapes of the corresponding surfaces, respectively. Since the plural antennas are disposed at different positions and have different directivities, respectively, the antenna group has directivities in different directions. The switching control unit determines an optimum directivity suitable for receiving broadcast signals on a selected channel among those of the antenna group. Thus desired broadcast signals can be received always in a high sensitivity regardless of the directional position of the television receiver. Since the antennas are formed so as to extend along the surfaces, the antennas will not obstruct the arrangement of the component parts.

At least some of the plural antennas may be formed on the inner surface of the rear wall of the cabinet. It is desirable to form the antennas in the largest possible area at many positions to ensure satisfactory directivities in all directions. The rear wall of the cabinet that has the largest area among the walls of the cabinet and a large space not containing component parts is available in the vicinity of the rear wall. Therefore, it is desirable, from the view point of improving receiving ability and designing the interior of the television receiver, to form the antennas on the inner surface of the rear wall.

Some of the plural antennas may be substantially horizontally orientated. In most cases, broadcast television signals are horizontally polarized waves. Therefore, broadcast television signals can be satisfactorily received when some of the antennas are substantially horizontally orientated. However, to receive vertically polarized waves satisfactorily, at least some of the rest of the antennas may be vertically orientated.

Each of the antennas may be formed by attaching a metal part having the shape of a dipole antenna to the surface. Since the antenna thus formed scarcely needs a space in the cabinet, the antenna is not an obstruct to other component parts and greatly contributes to forming the cabinet in a small thickness. Since the metal part of each antenna has the shape of a dipole antenna, the antenna can precisely receive broadcast signals.

The switching control unit executes a procedure for adjusting the phases of the broadcast signals received by the antennas, synthesizing the phase-adjusted signals to generate a composite signal and determining the error rate of a frequency signal extracted from the composite signal plural cycles for different phase adjustments for the broadcast signals received by the antennas. The switching control unit may use a phase adjustment for the cycle in which a minimum error rate is determined for adjusting the phases of the broadcast signals received by the antennas to specify a directivity for the antenna group. Thus the antenna group can be regarded as being equivalent to a smart antenna. Error rates of signals are detected by sequentially changing the directivity of the antenna group, the directivity of the antenna group when a minimum error rate is detected is used for receiving broadcast signals. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary illustration of a perspective view of a television receiver (TV receiver);

FIG. 2 is an exemplary illustration of a front elevation of a rear cabinet on which antennas are arranged;

FIG. 3 is an exemplary illustration of a front elevation of an antenna;

FIG. 4 is an exemplary illustration of a front elevation of another antenna;

FIG. 5 is an exemplary illustration of a front elevation of third antenna;

FIG. 6 is an exemplary illustration of a perspective view of the rear cabinet on which antennas are arranged in another arrangement;

FIG. 7 is an exemplary illustration of a perspective view of the rear cabinet on which antennas are arranged in a third arrangement;

FIG. 8 is an exemplary illustration of a block diagram of internal component parts of the TV receiver;

FIG. 9 is an exemplary illustration of a flow chart of a directivity specifying procedure; and

FIG. 10 is an exemplary illustration of a phase adjustment table.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized. For purposes of illustration, programs and other executable program components are illustrated herein as discrete blocks, although it is recognized that such programs and components may reside at various times in different storage components, and are executed by the data processor(s) of the computers. Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. A preferred embodiment of the present invention will be descried with reference to the accompanying drawings in the following order.

1. Arrangement of antennas on television receiver

2. Signal receiving procedure for receiving broadcast signals

3. Conclusion

### 1. ARRANGEMENT OF ANTENNAS ON TELEVISION RECEIVER

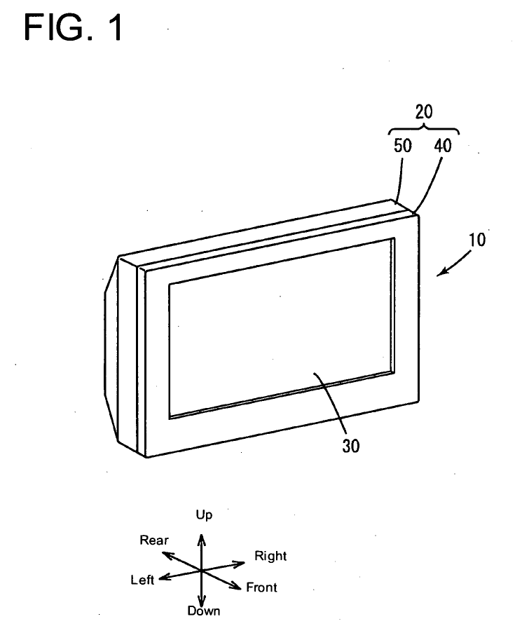

FIG. 1 shows a television receiver (hereinafter, referred to as “TV receiver”) 10 in a preferred embodiment according to the present invention in a perspective view taken from the front side of the TV receiver 10. The TV receiver 10 has, in its appearance, a cabinet (case) 20, and a display panel 30 set in the cabinet with its display surface exposed. The cabinet 20 has a front cabinet 40 covering upper, lower, right and left edge parts of the display panel 30 from the front side, and a rear cabinet 50 covering the display panel 30 and other component parts of the TV receiver 10 from the rear side.

The display panel 30 of the TV receiver 10 is a thin liquid crystal display panel. Therefore, the TV receiver 10 is a liquid crystal TV receiver. The thin display panel of the TV receiver 10 is not limited to the liquid crystal display panel and may be any suitable one of various display panels, such as plasma display panels and organic electroluminescent display panels (organic EL display panels).

Plural antennas for receiving broadcast television signals are integrated with the TV receiver 10. Positions of the antennas on the TV receiver 10 are in the inner and the outer surfaces of the walls of the cabinet 20 and the nonmetallic surfaces of component parts arranged in the cabinet 20. Preferable methods of arranging the antennas in the TV receiver 10 will be described.

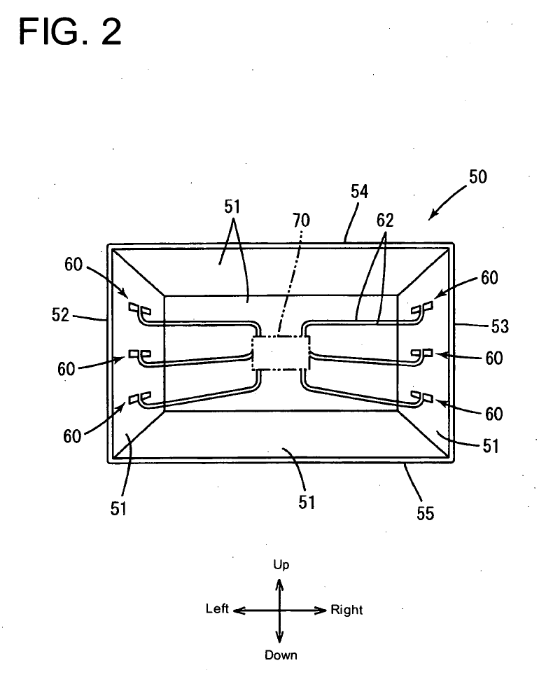

FIG. 2 is a front elevation of the rear cabinet 50.

The rear cabinet 50 has, as principal members, a rear wall 51, a right-hand side wall 53 extending forward from the right edge of the rear wall 51, a left-hand side wall 52 extending forward from the left edge of the rear wall 51, an upper wall 54 extending forward from the upper edge of the rear wall 51, and a lower wall 55 extending forward from the lower edge of the rear wall 51. The rear wall 51 is the rear wall of the cabinet 20 as well.

FIG. 2 shows plural antennas 60 disposed symmetrically with respect to a vertical central plane on the inner surfaces, namely, surfaces facing the interior of the TV receiver 10, of the rear wall 51 of the rear cabinet 50.

More concretely, the six antennas 60 are disposed symmetrical with respect to a vertical central plane at six positions on the rear wall 51. The three antennas 60 are arranged vertically at vertical intervals on the right-hand inner surface of the rear wall 51, and three antennas 60 are arranged vertically at vertical intervals on the left-hand inner surface of the rear wall 51.

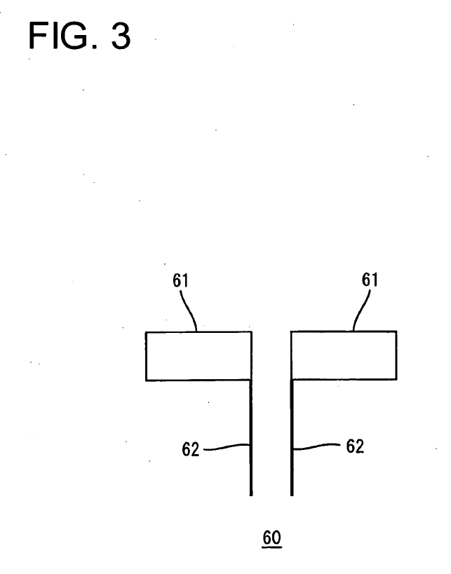

Referring to FIG. 3 showing an antenna 60 in Example 1, the antenna 60 has two antenna elements 61 and two conductors 62 connected to the antenna elements 61, respectively. The antenna elements 61 are metal sheets made of a predetermined metal and attached to or metal films of a predetermined metal formed on the inner surface of, for example, the right-hand side wall 53 in the shape of a dipole antenna. Actually, the antennas 60 are dipole antennas. Each of the antenna elements 61 of the antennas 60 can be formed at a desired position by various methods. For example, the antenna element 61 may be a piece of metal foil, such as copper foil, attached to the inner surface, an aggregate of conductors attached to the inner surface, a film painted on the inner surface, a film of a conductive paint applied to the inner surface. Thus, when the surface on which the antenna element 60 is formed is curved, the antennal element 61 is curved so as to conform to the curved surface.

The conductors 62 connected to each antenna 60 are connected to an output adjusting unit 70. The output adjusting unit 70 may be disposed at a predetermined position, such as a substantially central position, on the inner surface of the rear wall 51 as indicated by dotted lines in FIG. 2 or on a wiring board, not shown, disposed in the cabinet 20. The output adjusting unit 70 is a component part of a switching control unit. A combination of an antenna group 65 including the plural antennas 60 integrated with the TV receiver 10 and the output adjusting unit 70 can be referred to as an antenna unit. Functions of the output adjusting unit 70 will be described later.

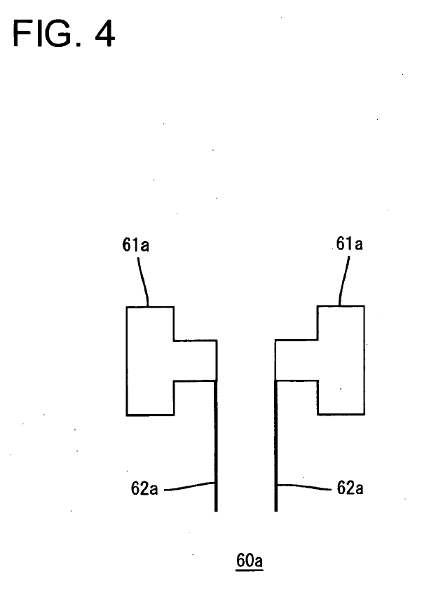

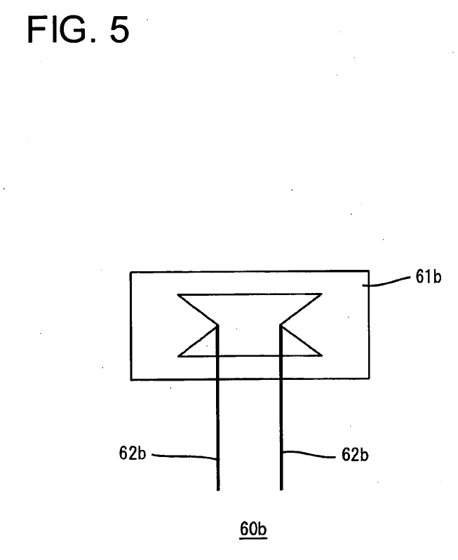

FIGS. 4 and 5 show antenna elements in Examples 2 and 3, respectively.

Referring to FIG. 4 showing an antenna 60a in Example 2, the antenna 60a has two antenna elements 61a and two conductors 62a connected to the antenna elements 61a, respectively. The antenna elements 61a are T-shaped pieces of metal foil. The antenna elements 61a are arranged such that the stems of the T-shaped antenna elements 61a are opposite to each other. The antenna elements 60a shown in FIG. 4 may be attached, instead of the antenna elements 60 shown in FIG. 3, to predetermined parts of the inner surfaces of the side walls 52 and 53.

Referring to FIG. 5 showing an antenna 60b in Example 3, the antenna 60b is formed by forming an opening having a shape substantially resembling the numeral 8 in a central part of a substantially rectangular antenna element 61b of metal foil. The antenna element 60b shown in FIG. 5 may be attached, instead of the antenna elements 60 and 60a shown in FIGS. 3 and 4, to a predetermined parts of the inner surfaces of the side walls 52 and 53. Conductors 62b are connected to the tips of opposite projections projecting into the opening having the shape substantially resembling the numeral 8.

The antenna 60 mentioned in this specification can be optionally set as the antenna 60a or the antenna 60b.

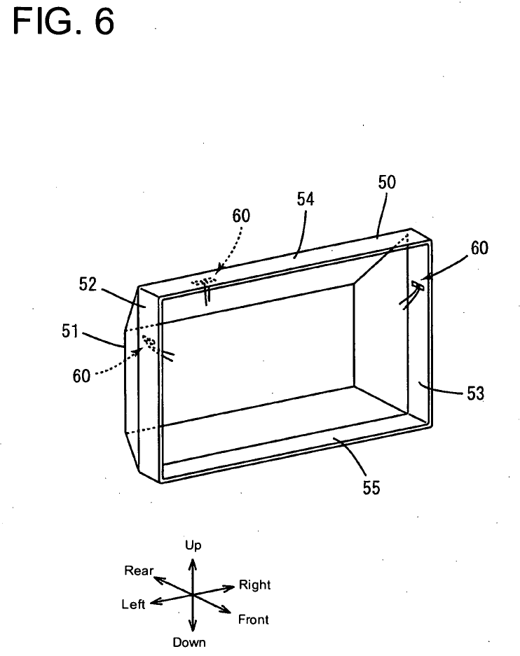

The positions of the antennas 60 are not limited to those shown in FIG. 2. For example, as the rear cabinet 50 shown in FIG. 6, the antennas 60 may be disposed at positions on the respective inner surfaces of the right-hand side wall 53 and the left-hand side wall 52 of the rear cabinet 50 in addition to the positions shown in FIG. 2 or instead of disposing at the positions shown in FIG. 2. The antennas 60 may be disposed on the inner surface of the upper wall 54 of the rear cabinet 50. The number of the antennas 60 is not limited to six. Basically, the number and the positions of the antennas 60 may be optionally determined. However, it is not necessarily suitable to dispose the antennas 60 on the lower wall 55. Although it is desirable to dispose the antennas of the TV receiver 10 at the highest possible positions to receive broadcast signals satisfactorily, the lower wall 55 is a part nearest to the floor of the TV receiver 10 and is an unsuitable part on which antennas are disposed. From such point of view, it is a preferable arrangement of the antennas 60 for the TV receiver 10 of the present invention to distribute the antennas 60 symmetrically with respect to a vertical center plane on the continuous inner surfaces of the rear wall 51, the upper wall 54, the right-hand side wall 53 and the left-hand side wall 52 of the rear cabinet 50.

In this embodiment, at least one set of the antennas 60 symmetrical with respect to a vertical center line among the plural antennas 60 formed on the inner surface of the rear cabinet 50 shall be formed on the rear wall 51 because the largest space for forming the antennas 60 can be easily available on the inner surface of the rear wall 51 among the inner surfaces of the walls of the thin TV receiver 10. The receiving sensitivity of the antennas 60 can be improved by forming the antenna elements 61 in a large area. The antenna elements 61 of the antennas 60 formed on the wide inner surface of the rear wall 51 can be easily formed in a large area.

The antennas 60 can be disposed in different directions. For example, at least some of the plural antennas 60, such as at least one set of the symmetrically disposed antennas 60, are formed in a substantially horizontal orientation; that is, the length of the antenna elements 61 are extended horizontally (laterally). Since broadcast television signals are horizontally polarized waves, broadcast television signals can be satisfactorily received when the antennas 60 are placed in a substantially horizontal orientation.

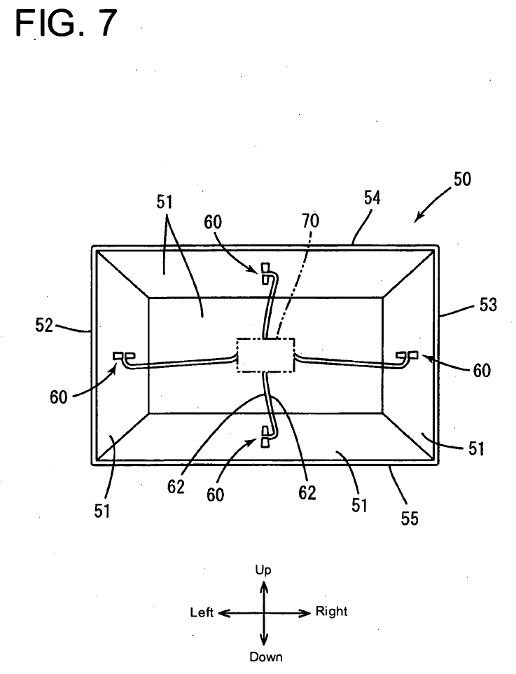

FIG. 7 shows an arrangement of the antennas 60 on the inner surface of the cabinet 50 different from those shown in FIGS. 2 and 6. In FIG. 7, some of the antennas 60 are disposed in a horizontal orientation and some other antennas 60 are disposed in a vertical orientation. To enable the TV receiver 10 to receive both horizontally polarized waves and horizontally polarized waves satisfactorily, some of the antennas 60 are disposed in a horizontal orientation and some other antennas 60 are disposed in a vertical orientation.

The positions of the antennas 60 are not limited on those on the inner surface of the rear cabinet 50. For example, the positions may be on the surfaces of the nonmetallic parts of any of the component parts of the TV receiver 10, such as on the outer surface of the rear cabinet 50, on the inner and the outer surface of the front cabinet 40 and/or on the display surface of the display panel 30.

### 2. SIGNAL RECEIVING PROCEDURE

A signal receiving procedure for receiving broadcast signals by the antenna group 65 will be described.

The antennas 60 of this embodiment can individually receive broadcast signals and have different directivity according to their positions and orientations. Thus, an antenna system having satisfactory sensitivities in different directions can be constructed by arranging the plural antennas 60 at different positions in different orientations, respectively. However, if the antenna system can always receive broadcast signals from all directions, noise radio waves from directions other than a direction from which broadcast signals from a desired broadcast station are received. Therefore, this embodiment executes a control operation to selectively determine a directivity for receiving signals on a desired channel.

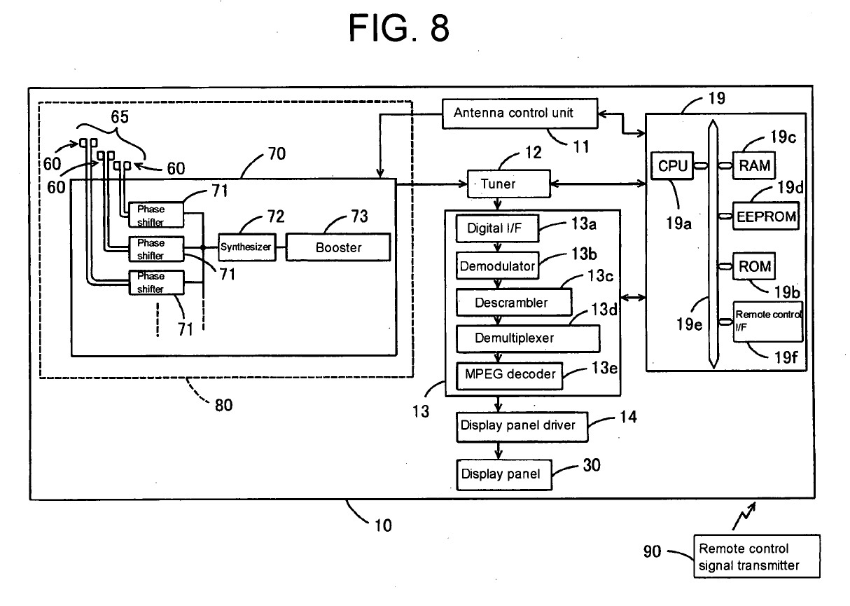

FIG. 8 is a general block diagram of the TV receiver 10.

The TV receiver 10 has an antenna unit 80 including the antenna group 65 and the output adjusting unit 70. The output adjusting unit 70 includes plural phase shifters 71 respectively connected to the antennas 60, synthesizer 72 connected to the phase shifters 71, and a booster circuit 73 connected to the synthesizer 72. The TV receiver 10 has an antenna control unit 11, a tuner 12, a signal regeneration unit 13, a display panel driver 14, and the display panel 30. The antenna control unit 11, the tuner 12, and the signal regeneration unit 13 are connected to a microcomputer 19. Although only the three antennas 60 are shown in FIG. 8 for simplicity, it does not mean that the number of the antennas 60 of the antenna group 65 is three.

The microcomputer 19 has a CPU 19a, a ROM 19b, a RAM 19c, an EEPROM 19d, namely, a rewritable nonvolatile storage device, and a bus 19e interconnecting those components. The CPU 19a executes a control procedure for realizing the functions of the TV receiver 10 using the RAM 19c as a work area. A program specifying the control procedure is stored beforehand in the ROM 19b. The CPU 19a reads the predetermined program from the ROM 19b to carry out the control procedure. The predetermined program read from the ROM 19b is written to the RAM 19c during the control procedure. The CPU 19a uses data stored in the EEPROM 19d for carrying out the control procedure.

Operations of the TV receiver 10 when a channel signal indicating a channel selected by the user is given to the TV receiver 10 will be described. The user operates a remote control signal transmitter 90 to send a channel signal specifying a desired channel to the TV receiver 10. A remote control interface (I/F) 19f connected to the bus 19e receives an infrared blinking signal provided by the remote control signal transmitter 90. The infrared blinking signal is transmitted by the bus 19e to the CPU 19a, and the CPU 19a executes a control procedure specified by the infrared blinking signal.

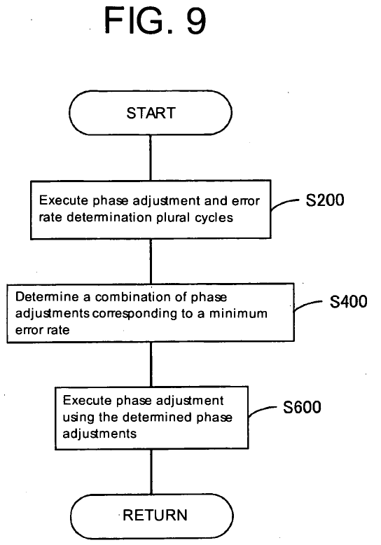

Upon the reception of a channel selection instruction, the CPU 19a controls the antenna control unit 11, the tuner 12 and the signal regeneration unit 13 to execute a channel selection procedure for selecting an optimum directivity for receiving broadcast signals on a channel specified by the channel selection instruction. FIG. 9 is a flow chart of the channel selection procedure.

In step S200, the CPU 19a repeats an error rate determining cycle for determining an error rate in a frequency signal obtained by adjusting the phases of broadcast signals received by the antennas 60 several times changing phase adjustments for the broadcast signals received by the antennas 60.

The antenna control unit 11 controls phase adjustments for the phase shifters 71. Each phase shifter 71 can change the phase of an input signal received from the corresponding antenna 60. The phase shifter 71 can delay the phase of the input signal according to a bias voltage provided by the antenna control unit 11. The antenna control unit 11 refers to a predetermined phase adjustment table T showing combinations of phase adjustments and the phase shifters 71 respectively corresponding to the antennas 60 to determine phase adjustments respectively for the phase shifters 71, and applies bias voltages corresponding to the phase adjustments to the phase shifters 71, respectively.

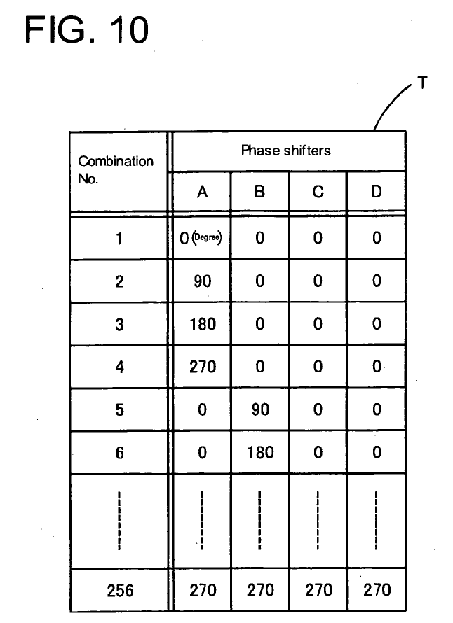

FIG. 10 shows the phase adjustment table T by way of example. The phase adjustment table T is stored beforehand in, for example, the EEPROM 19d. Supposing that the antenna group 65 has the four antennas 60 to simplify explanation, the four phase shifters 71 respectively corresponding to the four antennas 60 are indicated by phase shifters A, B, C and D in table T. Phase adjustments for the phase shifters A to D are determined by 90°. Since four phase adjustments 0°, 90°, 180° and 270° are assigned to each of the four phase shifters A to D, there are 256 combinations (44 combinations) of the phase adjustments. FIG. 10 shows the phase adjustment combinations Nos. 1 to 256. Needless to say, phase adjustments may be determined by an angle smaller than 90°.

The antenna control unit 11 reads the combinations of the phase adjustments for the phase shifters A to D sequentially from the phase adjustment table T and applies bias voltages corresponding to the phase adjustments to the phase shifters A to D, respectively. Consequently, the phase shifters A to D give phase-shifted signals to the synthesizer 72. The synthesizer 72 synthesizes the input signals to give a composite signal to the booster 73. The booster 73 amplifies the composite signal received from the synthesizer. An output signal provided by the booster 73, namely, an output signal provided by the antenna unit 80, is given to the tuner 12.

Thus, the antenna group 65 can have a directivity in an optional direction in addition to the directivities of the antennas 60, and can optionally change directivity by changing the phases of the input signals received from the plural antennas 60 and composing the phase-changed signals. In this respect, the antenna group 65 is a group of antennas respectively having variable directivities.

The CPU 19a gives a channel selection control signal specifying the frequency band of signals on the channel specified by the channel signal to the tuner 12. Then, the tuner 12 extracts a frequency signal indicating a frequency in the frequency band specified by the channel selection control signal from the frequency signals received from the antenna unit 80 to choose one channel from the plural channels.

The tuner 12 gives a signal to the signal regeneration unit 13. In the signal regeneration unit 13, an I/F 13a converts the frequency signal received from the tuner 12 into a corresponding digital signal, a demodulator 13b processes the digital signal by a ghost cancellation process and corrects bit errors introduced into the digital signal during transmission to provide a transport stream (TS). The demodulator 13b determines an error rate, namely, the ratio of bit errors to all the data.

In step S200, such an error rate determining process is executed for each of signals corresponding to the phase adjustments shown in the Table T.

In step S400, the CPU 19a specifies a combination of phase adjustments for the phase shifters corresponding to the signal having a minimum error rate among the error rates determined in step S200. In steps S200 and S400, the error rate determining process may be ended upon the determination of an error rate not higher than a predetermined value and a combination of the phase adjustments corresponding to the minimum error rate at that time may be specified instead of determining error rates for all the combinations of all the phase adjustments shown in Table T.

In step S600, the CPU 19a gives an instruction requesting adjusting the phases of the phase shifters on the basis of the combination of the phase adjustments for the phase shifters determined in step S400 to the antenna control unit 11. Then, the antenna control unit 11 generates bias voltages for the phase shifters on the basis of the specified phase adjustments for the phase shifters, and applies the bias voltages to the phase shifters.

Thus, a directivity optimum for receiving broadcast signals on the channel selected by the user is determined for the antenna group 65. Consequently, the broadcast signals can be received in a satisfactory receiving sensitivity and the reception of unnecessary noise radio waves is suppressed to the least. A configuration including at least the output adjusting unit 70, the antenna control unit 11, the demodulator 13b of the signal regeneration unit 13, and the CPU 19a (the microcomputer 19) may be called the switching control unit of the present invention.

After the completion of step S600, the TV receiver 10 executes an ordinary video regeneration process. In the signal regeneration unit 13, the demodulator 13b obtains the TS on the basis of the frequency signal received from the tuner 12, a descrambler 13c processes the TS by a descrambling process to convert the TS into a data array that can be regenerated. The signal obtained by processing the TS by the descramble process is a multiplex signal including video signals, audio signals and signals representing character information. This multiplex signal is given to a demultiplexer 13d. The demultiplexer 13d processes the received data by a demultiplexing process to separate the signals of the multiplex signal. Then, the separated video signals and the audio signals are compressed by a predetermined method to provide MPEG data. The MPEG data is given to an MPEG decoder 13e. The MPEG decoder 13e executes a decompression process, namely, a MPEG decoding process, to provide digital video signals and digital audio signals. The digital video signals thus generated are converted into analog video signals. Then, the signal regenerating unit 13 gives the analog video signals obtained through decompression and D/A conversion to the display panel driver 14. Then, the display panel driver 14 gives the video signals to the display panel 30. The audio signals generated by the MPEG decoding process is subjected to D/A conversion. A sound output circuit and a loudspeaker, not shown, generates sounds represented by audio signals obtained through D/A conversion.

In the foregoing description, it is supposed that a loop of steps S200 to S600 is executed every time the user selects a desired channel. The phase shifters may be adjusted, when the channels are selected, on the basis of information about predetermined optimum combinations of phase adjustments for the phase shifters respectively for the channels determined beforehand by executing the loop of steps S200 to S600 for the channels at a channel-presetting stage. A process for previously determining such information about the combinations needs to be executed every time the position where the TV receiver 10 is installed is changed.

The signal given to the tuner 12 by the output adjusting unit 70 may be generated by a process other than the foregoing process. For example, the output adjusting unit 70 may equalize the phases of signals provided by the antennas 60 by the phase shifters 71, may synthesize signals obtained by weighting the signals by weighting coefficient corresponding to the intensities of the signals and may give the synthesized signal to the tuner 12. The output adjusting unit 70 may give a signal to the tuner 12 by a simpler process including choosing a signal of the highest intensity from the signals received from the antennas 60 and giving the chosen signal to the tuner 12.

### 3. CONCLUSION

In the TV receiver 10 in this embodiment provided with the thin display panel, such as a liquid crystal display panel, held in the cabinet 20, the plural antennas 60 are formed by attaching metal sheets of metal foil or the like to the plural parts of the surface of a component part of the TV receiver, such as the inner surface of the rear cabinet 50, so as to conform to the surface or by forming metal films on those parts to build the antenna group having plural variable directivities. When the user selects a desired channel, an optimum directivity for receiving broadcast signals on that channel is determined for the antenna group 65. The TV receiver 10 does not need to be provided with an antenna projecting from the surface of the cabinet 20. The TV receiver 10 can receive all the broadcast signals from all the directions regardless of the orientation thereof and can receive only broadcast signals broadcast by a broadcast station desired by the user in satisfactory sensitivity.

Each of the antennas 60 is formed from metal foil or the like so as to conform to the shape of the surface on which the antenna 60 is formed. Thus, the antenna 60 having a very small volume does not obstruct the arrangement of the component parts of the TV receiver 10 including, for example, the display panel 30, the power circuit, the signal processing circuits, the loud speakers and the inverter circuit for driving the back light of the liquid crystal display panel in the cabinet 20. Therefore, the plural antennas 60 formed inside the TV receiver 10 do not obstruct forming the cabinet 20 in a small thickness at all and effectively contribute to reducing the thickness of the cabinet 20. Since the existence of the antennas 60 inside the TV receiver 10 is practically ignorable, the degree of freedom of designing and arranging the other component parts can be remarkably increased as compared with a conventional TV receiver provided with a large antenna inside the cabinet.

The technical idea of the present invention is applicable to liquid crystal TV receivers. A liquid crystal TV receiver integrally provided with an antenna function for receiving broadcast signals, comprising: a rear cabinet including a rear wall, an upper wall and right and left side walls; an antenna group having plural directivities and including six or more antennas of metal foil having the shape of a dipole antenna and arranged symmetrically with respect to a vertical central plane of the rear wall on six or more positions of a continuous area including inner surfaces of the rear wall, the upper wall and the right and left side walls; and a switching control unit for determining a directivity for the antenna group and making the antenna group receive broadcast signals; at least one set of the antennas symmetrical with respect to the vertical central plane among the antennas is formed on the inner surface of the rear wall in a substantially horizontal orientation, and the switching control unit repeats a procedure for adjusting the phases of the broadcast signals received by the antennas, synthesizing the phase-adjusted signals to generate a composite signal and determining an error rate in a signal of a predetermined frequency extracted from the composite signal plural cycles, which change phase adjustments for the broadcast signals received by the antennas; the switching control unit further determines a directivity for the antenna group by adjusting the phases of the broadcast signals received by the antennas by using the phase adjustments used by the cycle in which a minimum error rate is determined.

Thus, the liquid crystal TV receiver having the foregoing concrete configuration can exhibits operations and effects similar to those of the foregoing TV receiver.

While the invention has been particularly shown and described with respect to preferred embodiments thereof, it should be understood by those skilled in the art that the foregoing and other changes in form and detail may be made therein without departing from the spirit and scope of the invention as defined in the appended claims.

What is claimed is:

1. A television receiver integrally provided with an antenna function for receiving broadcast signals, comprising:
an antenna group having plural directivities and including plural antennas formed in plural positions on inner and outer surfaces of walls of a cabinet of the television receiver and/or on nonmetallic surfaces of components arranged in the cabinet so as to conform to shapes of the corresponding surfaces, respectively; and
a switching control unit capable of specifying a directivity for the antenna group to receive broadcast signals by the antenna group.

2. The television receiver according to claim 1, wherein at least some of the plural antennas are formed on the inner surface of a rear wall of the cabinet.

3. The television receiver according to claim 1, wherein at least some of the plural antennas are substantially horizontally orientated.

4. The television receiver according to claim 3, wherein at least some of the plural antennas are substantially vertically oriented.

5. The television receiver according to claim 1, wherein each of the antennas is formed by attaching a metal part having the shape of a dipole antenna to the corresponding surface.

6. The television receiver according to claim 1, wherein the switching control unit repeats a procedure for adjusting the phases of the broadcast signals received by the antennas, synthesizing the phase-adjusted signals to generate a composite signal, and determining a error rate of a frequency signal extracted from the composite signal plural cycles for different phase adjustments for the broadcast signals received by the antennas, the switching control unit uses a phase adjustment for the cycle in which a minimum error rate is determined for adjusting the phases of the broadcast signals received by the antennas to specify a directivity for the antenna group.

7. A liquid crystal television receiver integrally provided with an antenna function for receiving broadcast signals, comprising:
a rear cabinet including a rear wall, an upper wall and right and left side walls;
an antenna group having plural directivities and including six or more antennas of metal foil having the shape of a dipole antenna and arranged symmetrically with respect to a vertical central plane of the rear wall on six or more positions of a continuous area including inner surfaces of the rear wall, the upper wall and the right and left side walls; and
a switching control unit for determining a directivity for the antenna group and making the antenna group receive broadcast signals;
at least one set of the antennas symmetrical with respect to the vertical central plane among the antennas is formed on the inner surface of the rear wall in a substantially horizontal orientation, and
the switching control unit repeats a procedure for adjusting the phases of the broadcast signals received by the antennas, synthesizing the phase-adjusted signals to generate a composite signal and determining an error rate in a signal of a predetermined frequency extracted from the composite signal plural cycles, which change phase adjustments for the broadcast signals received by the antennas;
the switching control unit further determines a directivity for the antenna group by adjusting the phases of the broadcast signals received by the antennas by using the phase adjustments used by the cycle in which a minimum error rate is determined.
